(19) United States
(12) Patent Application Publication
(10) Pub. No.: US 2006/0176018 A1
(43) Pub. Date: Aug. 10, 2006

(54) METHOD AND ARRANGEMENT FOR BATTERY CHARGING

(75) Inventors: Hans Westerlind, S-449 40 Nol (SE); Lasse Ryden, S-415 06 Göteborg (SE); Olof Martandar, S-428 34 Kållered (SE); Mattias Lidgren, S-412 82 Göteborg (SE)

Correspondence Address: WHITE, REDWAY & BROWN LLP, PMB 285, 107 S. WEST STREET, ALEXANDRIA, VA, 22314, US

(73) Assignee: VOLVO LASTVAGNAR AB, Goteborg (SE)

(21) Appl. No.: 11/279,447

(22) Filed: Apr. 12, 2006

(30) Foreign Application Priority Data
Dec. 17, 2003 (SE) 0303448-5
Dec. 10, 2004 (WO) PCT/SE04/01841

(51) Int. Cl. H02J 7/00

(52) U.S. Cl. 320/116

(57) ABSTRACT

An arrangement for charging a plurality of batteries that are connected in series, where the total voltage across all the batteries that are connected in series is a predefined system voltage, includes an arrangement for controlling the voltage across each battery separately, so that the system voltage is not exceeded and so that the voltage across one of the batteries is higher than the voltage across each individual other battery. The arrangement can be arranged to be able to charge batteries on, for example, a vehicle with two batteries that are connected in series, where the charging voltage needs to be higher than half the system voltage and at the same time the system voltage is not permitted to exceed a predetermined level.

### BACKGROUND AND SUMMARY

The present application is a continuation of International Application PCT/SE2004/001841, filed Dec. 10, 2004, which claims priority to SE 0300448-5, filed Dec. 17, 2003, both of which are incorporated by reference.

The present invention relates to a method and an arrangement for charging batteries that are connected in series. By means of the invention, optimal charging of the individual batteries is made possible, while maintaining the system voltage. This is particularly advantageous in cold weather.

On many vehicles, in particular on heavy vehicles such as lorries, buses and construction machines, several batteries that are connected in series are used to provide the vehicle's system voltage. A normal system voltage is 24 volts, which is obtained by connecting two 12 volts batteries in series. The advantage of a higher system voltage is that the current to a component is lower and consequently thinner cables can be used. The power losses and the voltage drop in the cable are also reduced by a higher system voltage.

When a battery is to be charged, a charging voltage is required that exceeds the battery's terminal voltage in order for the battery to be able to be charged. The charging voltage must not be too high, approximately 1-2 volts higher than the battery's terminal voltage being a suitable charging voltage. If the charging voltage is much higher, the battery can be damaged and the vehicle's system voltage can exceed the maximum permitted system voltage with the result that the vehicle's other electrical components can be damaged.

Variations in the battery's terminal voltage depend on several parameters, with the most important of these being the state of charge of the battery and the temperature of the battery.

In, for example, cold weather, when the temperature of the batteries is low, a higher charging voltage is required to charge the batteries optimally. A normal way of compensating the charging voltage to the batteries in response to the temperature, is to use a temperature-compensating charging regulator. This has a charging characteristic that provides a higher output voltage at a lower temperature. The disadvantage of such a charging regulator is that the system voltage varies, which affects other components on the vehicle.

For example, the life of lamps is highly dependent upon the voltage. An additional disadvantage is that the charging regulator is integrated in the generator, which means that the temperature for which the charging regulator compensates is the engine compartment temperature and not the temperature of the batteries.

As the batteries are often located on the framework of the vehicle on heavy vehicles, this means that the batteries are not charged in an optimal way.

It is desirable therefore to achieve a method and an arrangement for charging batteries that are connected in series that makes it possible to charge each individual battery in an optimal way while maintaining the system voltage.

According to an aspect of the present invention, an arrangement for charging a plurality of batteries that are connected in series, where a total voltage across all the batteries that are connected in series comprises a predefined system voltage, comprises means for controlling voltage across each battery separately, so that a system voltage is not exceeded and so that a voltage across one of the batteries is higher than a voltage across each individual other battery.

According to another aspect of the present invention, a method for charging batteries that are connected in series comprises controlling a charging voltage across one of the batteries to be higher than a voltage across each individual other battery, and maintaining a total voltage across all the batteries that are connected in series at less than a predefined value.

According to a further aspect of the present invention, a computer program code for carrying out all the steps in the method described above when the program is executed by a computer is provided.

According to a further aspect of the present invention, a computer program product comprising program code stored on a medium that can be read by a computer is provided for carrying out the method described above when the program is executed by a computer.

With an arrangement for charging batteries that are connected in series, where the total voltage across all the batteries that are connected in series constitutes a predefined system voltage, the problem of the invention is solved by the arrangement comprising means for controlling the voltage across each battery separately, so that the system voltage is not exceeded.

The method according to the invention for charging batteries that are connected in series solves the problem by the charging voltage across one of the batteries being higher than the voltage across each individual other battery, while at the same time the total voltage across all the batteries that are connected in series is less than a predefined value.

By means of this first embodiment of the arrangement according to the invention, the charging voltage across each individual battery can be controlled separately.

The advantage of this is that the batteries on, for example, a lorry can be charged in an optimal way even in cold weather.

In an advantageous further development of the arrangement according to the invention, the arrangement can also measure the voltage across each individual battery. The advantage of this is that the charging procedure can be monitored better.

In an advantageous further development of the arrangement according to the invention, the arrangement can also measure the current to each individual battery. The advantage of this is that the charging procedure can be monitored better.

In an advantageous further development of the arrangement according to the invention, the arrangement can also determine the state of charge of each individual battery. The advantage of this is that the life of the batteries can be optimized.

### BRIEF DESCRIPTION OF DRAWINGS

The invention will be described in greater detail in the following, with reference to embodiments that are illustrated in the attached drawings, in which

FIG. 1 shows the required charging voltage as a function of temperature, and

FIG. 2 shows schematically an arrangement according to the invention.

### DETAILED DESCRIPTION

The following embodiments of the invention that are described here with further developments are only to be regarded as examples and are in no way to limit the scope of the protection of the patent claims. In the embodiments described here, lead acid batteries are used as examples of batteries. These batteries are commonly used in connection with vehicles. It should, however, be understood that other types of batteries can also be used, for which the required charging voltage is dependent upon temperature.

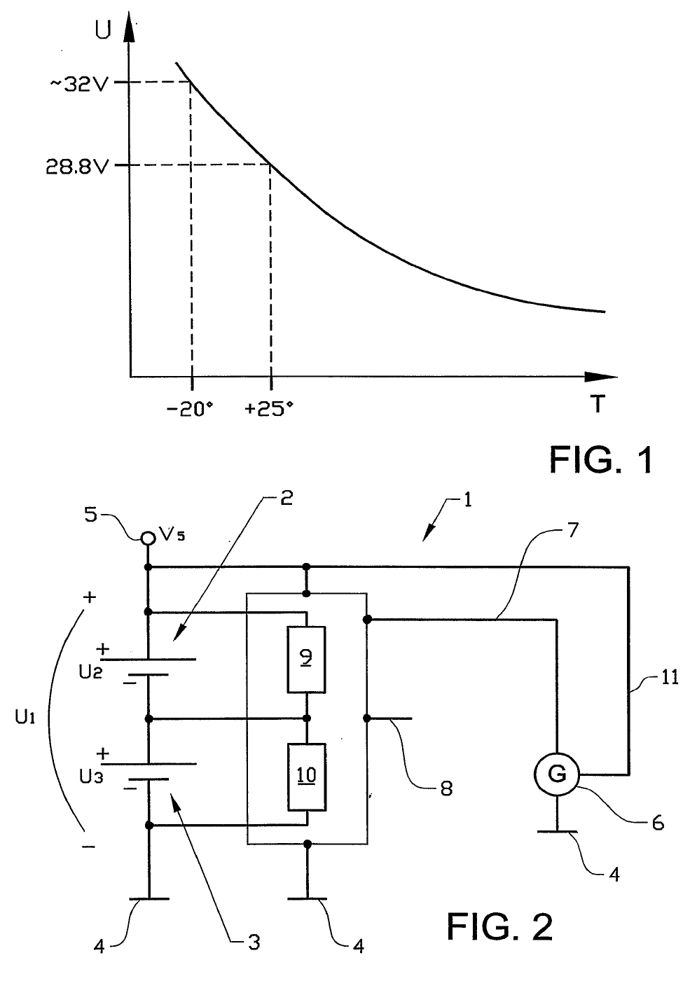

FIG. 1 shows the relationship between required charging voltage and battery temperature for a battery system with two lead acid batteries. As the charging voltage also constitutes the vehicle's system voltage, it is important that is not allowed to become too high.

This example relates to a typical battery system for a heavy vehicle, such as a lorry. The figures shown here are only to be regarded as an example and they can vary depending upon, for example, the type of battery and vehicle. From FIG. 1, it can be seen that at 25° C. the required charging voltage is 28.8 volts and at −20° C. the required charging voltage is approximately 32 volts. 32 volts is a common limit for the maximum permitted system voltage for heavy vehicles that use two lead acid batteries connected in series.

The maximum permitted system voltage is the voltage that all the components can withstand without breaking down. Control units and other electronic units are dimensioned with the maximum permitted system voltage as the upper voltage limit. The life of certain components is reduced, however, by increased voltage.

For example, the life of lamps is reduced by approximately 50% when the voltage is increased by 10%.

It is therefore desirable to limit the system voltage.

This can be carried out either by letting the charging regulator supply an output voltage that is permitted to vary so that the maximum voltage is below a particular level or by limiting the system voltage to a fixed voltage. The advantage of limiting the system voltage to a fixed voltage is that the voltage to the vehicle's components is known and accordingly, for example, the life of lamps can be calculated in a reliable way. The disadvantage of limiting the system voltage to a fixed voltage is that when the weather is cold, the charging voltage to the batteries is not as high as is desirable, which means that the batteries are not charged optimally when the weather is cold. A typical system voltage can, for example, be limited to 28.3 volts.

In theory, there is then a voltage of 14.15 volts across each battery. This voltage is normally higher than the steady voltage of the battery, whereby charging of the batteries is achieved. At low temperatures, it is on the other hand desirable to have a higher charging voltage across each battery. The required charging voltage is dependent upon temperature. A typical relationship between required charging voltage and temperature is shown in FIG. 1.

FIG. 2 shows a first embodiment of a charging arrangement 1 according to the invention. The arrangement 1 is connected to two batteries 2 and 3.

The voltage across both the batteries is called U1 and the voltages across each battery 2 and 3 are called U2 and U3 respectively. The batteries are connected to the vehicle via an earth connection 4 and a system voltage connection 5. In addition, the arrangement is connected to earth 4, to a generator 6 with built-in charging regulator via a lead 7 and to the output of the generator via a lead 11, which is also connected to the system voltage connection 5. The lead 7 is used to supply feedback to the charging regulator so that the required output voltage is obtained from the generator.

The arrangement has a control input 8 for controlling the arrangement. The control input 8 is connected to the vehicle's control system, either via a data bus to other control units or to a special control unit. The signal to the control input 8 can be analogue or digital. When the control input 8 is a data bus, it can also be used as an output when it is desired to send data and/or status information to other connected control units. The arrangement can, of course, also be equipped with more outputs and inputs that can be both analogue and digital as required.

The charging arrangement 1 comprises two regulating units 9,10 that are connected to the batteries 2 and 3 respectively. These regulating units are controlled via a control input 8. In response to, for example, the external temperature, the regulating units can vary the voltage across the respective batteries so that an optimal individual charging of the batteries is obtained.

In a normal state, for example in warm weather or when the batteries are fully charged, the voltages across the batteries are kept the same by the regulating units 9,10. When required, for example when the batteries need to be charged in cold weather, the regulating units can regulate the voltage across the batteries individually, so that the voltages across the individual batteries can be different.

This is carried out by the arrangement 1 receiving a signal via the input 8 to the effect that the external temperature is low and that the batteries need to be charged. The arrangement then controls, for example, the regulating unit 9 to maintain a voltage of 16 volts across battery 2, while at the same time the regulating unit 10 maintains a voltage across battery 3 that is such that the system voltage is maintained at 28.3 volts. When battery 2 is fully charged, the arrangement 1 controls the regulating unit 10 to maintain a voltage of 16 volts across battery 3, while at the same time the regulating unit 9 maintains a voltage across battery 2 that is such that the system voltage is 28.3 volts, until battery 3 is also fully charged.

Thereafter, the regulating units 9,10 return to maintaining the same voltage across battery 2 and battery 3 respectively.

The simplest way of controlling the charging of the batteries is to charge the batteries for certain period of time on the basis of an estimated charging requirement. After this period of time, the batteries are considered to be fully charged. This procedure is thereafter repeated as required.

The regulating units 9,10 are advantageously designed with a power semiconductor, for example some form of FET (Field Effect Transistor). The regulating units 9, 10 and other components, such as output and input protection, communication components, etc, are advantageously integrated in a compact unit, designed for use on a vehicle, with suitable connectors. It is also possible to integrate the arrangement in a larger unit, for example a second control unit.

In a first embodiment of the arrangement according to the invention, the arrangement comprises means for measuring the voltage of the batteries. The reason for measuring the voltage across the batteries is that the charging procedure can be monitored in a more precise way. This means that the terminal voltage of the batteries can be measured continually during the charging procedure. The charging procedure can thereby be controlled and monitored in a precise way.

In a second embodiment of the arrangement according to the invention, the arrangement comprises, in addition, means for measuring the charging current to the batteries. The reason for measuring the charging current to the batteries together with the charging voltage is that the total supplied energy can be determined. This increases the precision of the charging. In combination with measurement of the current consumed in the vehicle, for example by measuring the current through the vehicle's supply, the energy content of the battery can be determined with even greater precision.

In order to ensure that the batteries are not overcharged, it is advantageous to take into account the state of charge of the batteries during the charging. This can be carried out in several ways. One way is to measure the terminal voltage at the battery and, depending upon the external temperature, determine the state of charge. Another way is to measure the SOC (State of Charge) and SOH (State of Health) of the batteries and to use this information to determine the charging requirement of the batteries. The way of determining these states is known to experts within the field and is not considered here in greater detail.

In the method according to the invention for charging batteries that are connected in series, an optimal charging of each battery is achieved by the voltage across the batteries being able to be made asymmetric.

The voltage across a first battery is increased temporarily in order to charge the battery optimally, while at the same time the voltage across a second battery is reduced so that the system voltage is maintained. When the first battery is fully charged, the voltage across the battery is reduced, while at the same time the voltage across the second battery is increased. When both batteries are fully charged, the voltages across the batteries are controlled so that the voltages across the individual batteries are the same.

A computer program according to the invention comprises program code for charging batteries that are connected in series in an optimal way, by means of a charging arrangement according to the invention, when the program is executed by a processor integrated in the arrangement or in another control unit integrated in the vehicle.

The computer program according to the invention can be stored on a medium that can be read by a computer system integrated in the arrangement. This medium can, for example, be a diskette, a memory module, a CD or the like. This can be advantageous, for example when the program is to be downloaded into the vehicle during production and/or when the program in the vehicle is to be updated. The updating of the software can be carried out, for example, during fixed services or, if required, directly by a customer. The updating of the software can also be carried out via a data link, for example via the Internet, to a server in which the program is stored.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

The invention is not to be regarded as being limited to the embodiments described above, a number of additional variants and modifications being possible within the framework of the following patent claims. For example, battery systems with more than two batteries connected in series can use the method according to the invention to charge the batteries in an optimal way. In addition, the charging procedure is also suitable for stationary batteries that need to be charged when the weather is cold and where a system voltage must not be exceeded.

What is claimed is:

1. An arrangement for charging a plurality of batteries that are connected in series, where a total voltage across all the batteries that are connected in series comprises a predefined system voltage, comprising:
means for controlling voltage across each battery separately, so that a system voltage is not exceeded and so that a voltage across one of the batteries is higher than a voltage across each individual other battery.

2. The arrangement as claimed in claim 1, wherein the arrangement comprises a function for measuring voltage across each connected battery.

3. The arrangement as claimed in claim 2, wherein the arrangement comprises a function for measuring a charging current to each connected battery.

4. The arrangement as claimed in claim 3, wherein the arrangement comprises a function for determining a state of charge of each connected battery.

5. The arrangement as claimed in claim 1, wherein the arrangement comprises a function for measuring a charging current to each connected battery.

6. The arrangement as claimed in claim 5, wherein the arrangement comprises a function for determining a state of charge of each connected battery.

7. A system for charging batteries on a motor vehicle that are connected in series, comprising two batteries connected to an arrangement as claimed in claim 1.

8. The system as claimed in claim 7, wherein the arrangement is integrated in an electric distribution box on the vehicle.

9. A method for charging batteries that are connected in series, comprising:
controlling a charging voltage across one of the batteries to be higher than a voltage across each individual other battery; and
maintaining a total voltage across all the batteries that are connected in series at less than a predefined value.

10. The method as claimed in claim 9, comprising two batteries, and wherein a voltage across one battery is controlled to be higher than half the total voltage.

11. The method as claimed in claim 10, comprising determining a state of charge of each battery.

12. The method as claimed in claim 9, comprising determining a state of charge of each battery.

13. A computer program comprising program code for carrying out all the steps in claim 9 when the program is executed by a computer.

14. A computer program product comprising program code stored on a medium that can be read by a computer, for carrying out the method in claim 9 when the program is executed by a computer.
